(19) United States
(12) Patent Application Publication
(10) Pub. No.: US 2014/0366741 A1
(43) Pub. Date: Dec. 18, 2014

(54) TEA BREWING MACHINE

(71) Applicant: Ching-Shu Huang, Tainan City (TW)

(72) Inventor: Ching-Shu Huang, Tainan City (TW)

(21) Appl. No.: 14/142,151

(22) Filed: Dec. 27, 2013

(30) Foreign Application Priority Data
Jun. 18, 2013 (TW) 102121527

(51) Int. Cl. A47J 31/52

(52) U.S. Cl. CPC A47J 31/52
USPC 99/280

(57) ABSTRACT

A tea brewing machine includes: an upper cup having an aperture, a sealing plate movable vertically in the upper cup between a sealing position whereat the aperture is sealed by the sealing plate, and a non-sealing position whereat the aperture is not sealed by the sealing plate; a pushing unit disposed under the upper cup unit such that, when the pushing unit is in the non-pushing state, the sealing plate is at the sealing position, and when pushing unit is in the pushing state, the sealing plate is at the non-sealing position; a rotary knob; and a driving block disposed on the rotary knob. When the rotary knob is rotated in a timing direction, the driving block comes into contact with the pushing unit to convert the pushing unit into the pushing state.

### CROSS REFERENCE TO RELATED APPLICATION

The present application claims priority of Taiwanese Application No. 102121527, filed on Jun. 18, 2013, the entire disclosure of which is hereby expressly incorporated by reference herein.

### BACKGROUND OF THE INVENTION

1. Field of the Invention

This invention relates to a tea brewing machine, and more particularly to a tea brewing machine capable of setting brewing time.

2. Description of the Related Art

A conventional tea brewing machine disclosed in Taiwanese Patent No. 1272085 includes a main body, a connecting mount having a spring, a securing mount, a cup with a filtering cap, an upper cover, a timer, a driving unit, and a movable unit. The upper cover is rotatable to activate the timer which in turn drives the driving unit and, thus, the movable unit. Hence, the movable unit pushes the connecting mount to move downwardly, so that the cup and the filtering cap are removed from a bottom portion of the main body, thereby immersing tea leaves into hot water in the cup. As soon as the preset time of the timer is reached, the connecting mount is no longer pushed downwardly by the movable unit, and is biased by the spring to move upwardly to separate the tea leaves from the brewed liquid. In this manner, the brewing time can be controlled conveniently.

### SUMMARY OF THE INVENTION

The object of this invention is to provide another tea brewing machine that can control conveniently the brewing time.

According to this invention, a tea brewing machine includes: an upper cup having an aperture, a sealing plate movable vertically in the upper cup between a sealing position whereat the aperture is sealed by the sealing plate, and a non-sealing position whereat the aperture is not sealed by the sealing plate; a pushing unit disposed under the upper cup unit such that, when the pushing unit is in the non-pushing state, the sealing plate is at the sealing position, and when pushing unit is in the pushing state, the sealing plate is at the non-sealing position; a rotary knob; and a driving block disposed on the rotary knob. When the rotary knob is rotated in a timing direction, the driving block comes into contact with the pushing unit to convert the pushing unit into the pushing state.

As such, when the preset brewing time is reached, the driving block comes into contact with the pushing unit to move the sealing plate to the non-sealing position, so as to allow the brewed liquid to flow from the upper cup into a lower cup, thereby resulting in convenience during use.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of the preferred embodiment of a tea brewing machine according to this invention;

FIG. 2 is a sectional view of the preferred embodiment;

FIG. 3 is a fragmentary exploded perspective view of the preferred embodiment;

FIGS. 4 and 5 are fragmentary sectional views of the preferred embodiment, illustrating a non-pushing state of a pushing unit and a sealing position of a sealing plate;

FIG. 6 is an exploded perspective view of a timer device and a pivotable member of the preferred embodiment;

FIG. 7 is a fragmentary assembled perspective view of the preferred embodiment;

FIG. 8 is a partly sectional right side view of the preferred embodiment, illustrating that a driving block is located at a side of the pivotable member;

FIG. 9 is a view similar to FIG. 8 but illustrating that the driving block is located at an opposite side of the pivotable member;

FIG. 10 is a view similar to FIG. 8 but illustrating that a pressed section of the pivotable member is pressed by the driving block to pivot downwardly; and

FIG. 11 is a view similar to FIG. 4 but illustrating a pushing state of the pushing unit and a non-sealing position of the sealing plate.

### DETAILED DESCRIPTION OF THE PREFERRED EMBODIMENT

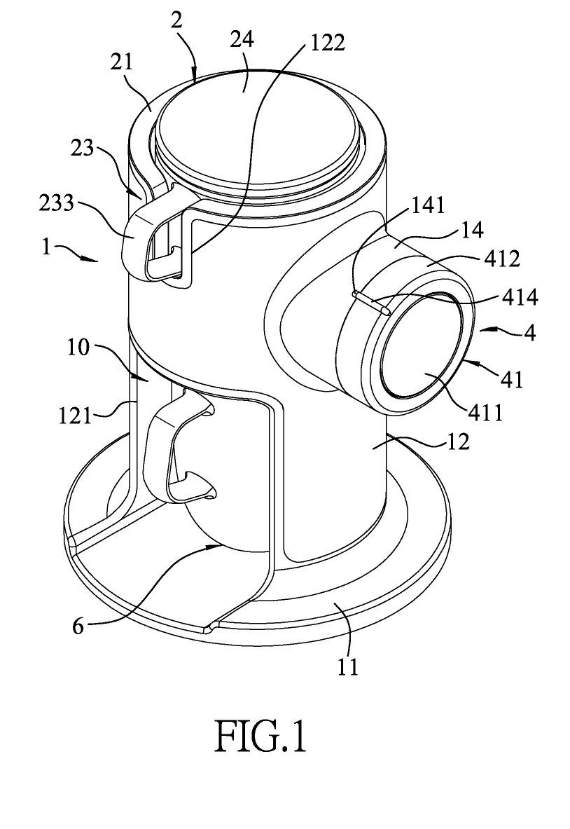

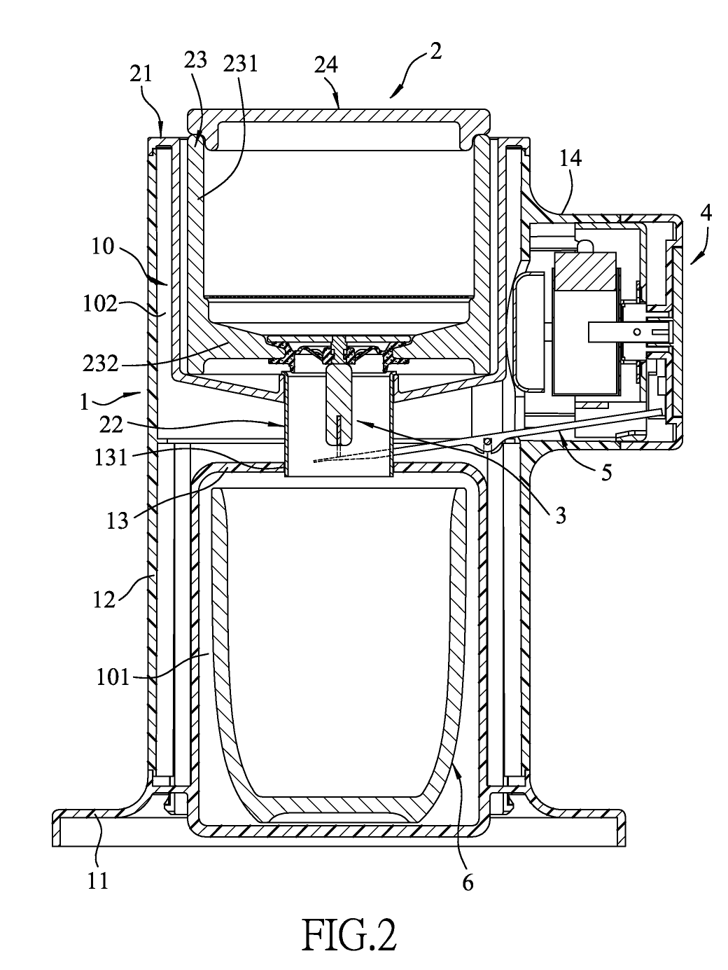

Referring to FIGS. 1, 2, and 3, the preferred embodiment of a tea brewing machine according to this invention can be used to brew tea leaves, tea bags, coffee powder, etc. In this embodiment, the tea brewing machine is exemplified by brewing tea leaves, and includes a base 1, an upper cup unit 2, a pushing unit 3, a timer device 4, and a lower cup 6.

The base 1 includes a horizontal base wall 11, a lower surrounding wall 12 extending upwardly from the base wall 11 and defining an accommodating space 10, a partition 13 connected to and disposed in the lower surrounding wall 12, and an annular mounting wall 14 extending laterally from an outer surface of the lower surrounding wall 12. The partition 13 divides the accommodating space 10 into a lower space portion 101 and an upper space portion 102 disposed above the lower space portion 101. The partition 13 has a hole 131 disposed between and in fluid communication with the upper and lower space portions 102, 102. The surrounding wall 12 has a lower end notch 121 and an upper end notch 122. The mounting wall 14 has an indication member 141 disposed on an outer surface thereof. The indication member 141 may be a mark or a projection. The base 1 may consist of a plurality of separate members, or may be formed as one piece.

The upper cup unit 2 is disposed within the upper space portion 102 of the base 1, and includes a hollow cup mounting member 21 disposed on the partition 13, a circular tube 22, an upper cup 23 disposed removably within the cup mounting member 21, a cap 24 covering removably a top end of the upper cup 23, a gasket 25 disposed in the upper cup 23, a sealing plate 26 disposed in the upper cup 23 and located above and abutting against the gasket 25, and a filtering net 27 disposed in the upper cup 23 and located above and abutting against the sealing plate 26.

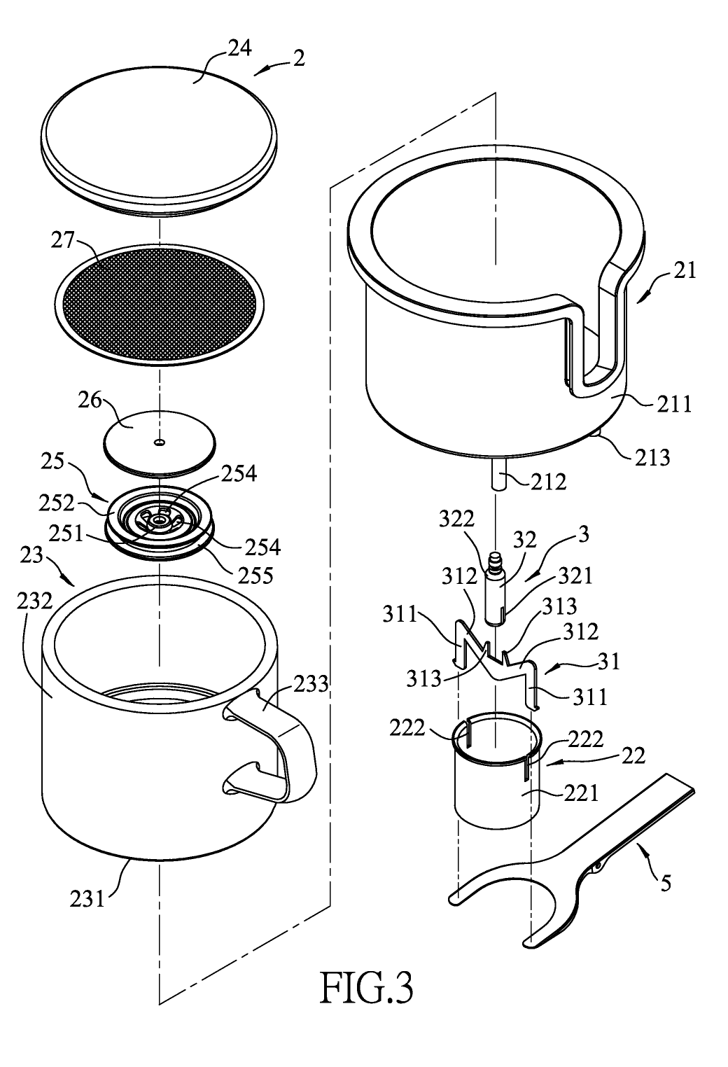

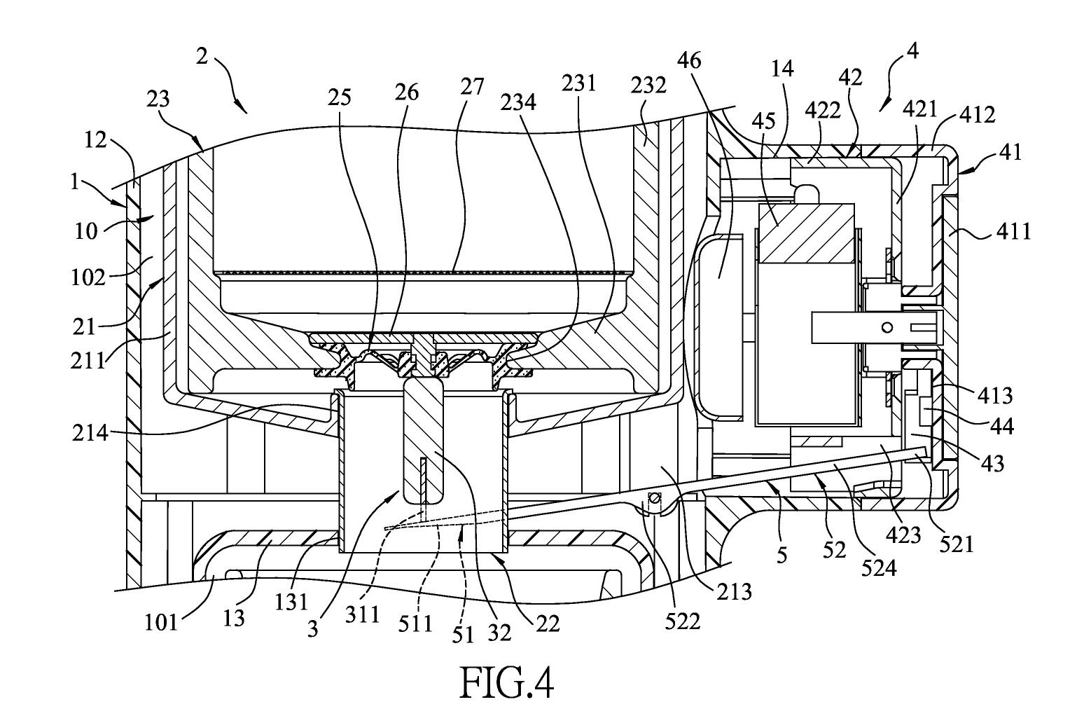

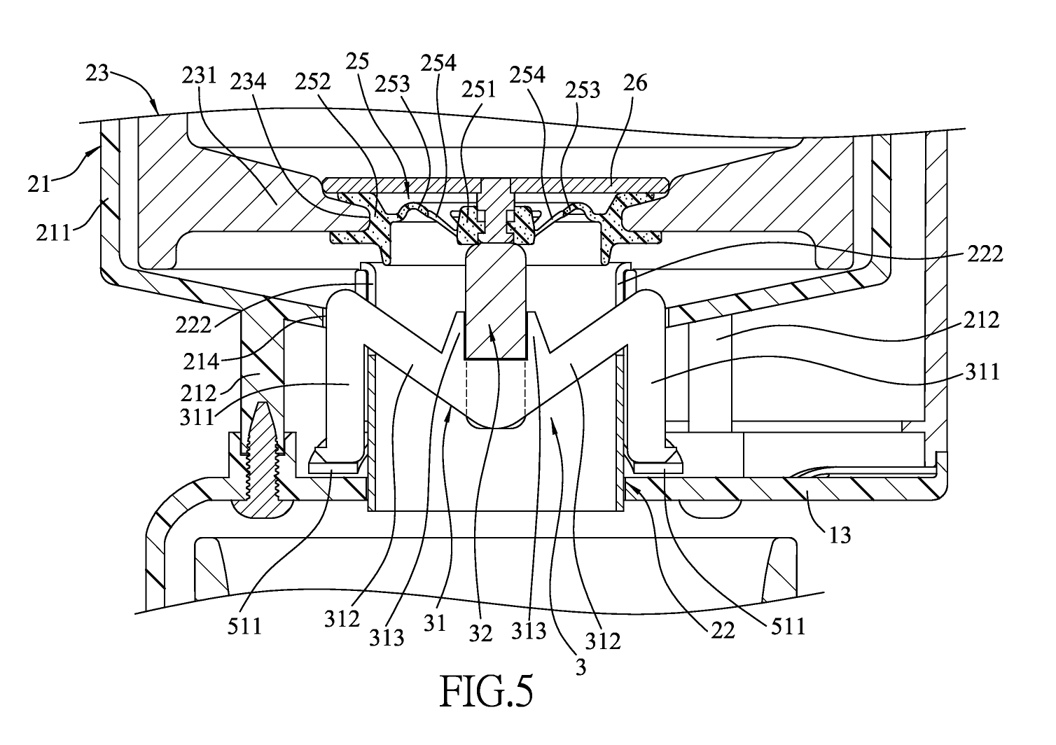

With further reference to FIGS. 4 and 5, the cup mounting member 21 includes: a hollow receiving body 211 having an opening 214 that is formed in a bottom end thereof and that is disposed under the aperture 234 in the upper cup 23; a plurality of spacer legs 212 extending downwardly from the hollow receiving body 211 and disposed removably on the partition 13 by bolts, such that the hollow receiving body 211 is spaced apart from and disposed above the partition 13; and two pivot legs 213 (only one is shown in FIG. 3) extending downwardly from the hollow receiving body 211. The circular tube 22 has a bottom end fixed on the partition 13 and extending into the hole 131 in the partition 13, and an open upper end extending into the cup mounting member 21 through the opening 214 and formed with two diametrically opposed slide slots 222 that have open upper ends.

The upper cup 23 has a bottom wall 231, a surrounding wall 232 extending upwardly from a periphery of the bottom wall 231, and a handle 233 extending through the upper end notch 122 in the cup mounting member 21 and having a portion exposed from the base 1. The bottom wall 231 has an aperture 234 aligned with the opening 214 in the cup mounting member 21. Alternatively, the cup mounting member 21 and base 1 may be formed as one piece.

The gasket 25 is made of a deformable silicone material, is fitted in the aperture 234 in the upper cup 23, is disposed directly above the circular tube 22, and has an inner ring portion 251, an outer ring portion 252 disposed around and spaced apart the inner ring portion 251, and a plurality of connecting portions 253 connected between the inner and outer ring portions 251, 252 and spaced apart from each other, so as to define a plurality of passages 254 each disposed among the inner and outer ring portions 251, 252 and two adjacent ones of the connecting portions 253. In this embodiment, the outer ring portion 252 is formed with an annular groove 255 (see FIG. 3) engaging fittingly an inner periphery of a wall defining the aperture 234 in the bottom wall 231 of the upper cup 23, so as to prevent movement of the outer ring portion 252 of the gasket relative to the upper cup 23, as best shown in FIG. 5.

The sealing plate 26 is a horizontal plate, and is disposed for sealing the aperture 234. The filtering net 27 is disposed for receiving tea leaves, and may be shaped as a flat plate or a bowl having a circular, rectangular, or triangular cross-section.

The pushing unit 3 is disposed under the upper cup unit 2, and includes a pushing member 31 movable vertically on the pushing member 31, a pushing post 32 disposed on and above the pushing member 31, and a pivotable member or seesaw member 5 disposed under the pushing member 31. The pushing member 31 is generally M-shaped, and has two upright pushed sections 311 disposed outwardly of the circular tube 22, two inclined extension sections 312 extending respectively from upper ends of the upright pushed sections 311 toward each other and connected to each other at lower ends of the inclined extension sections 312, and two holding sections 313 extending respectively from the inclined extension sections 312 and spaced apart from each other. The extension sections 312 extend into the circular tube 22 through the slide slots 222, respectively, such that the extension sections 312 can move vertically along the slide slots 222. The pushing post 32 is disposed on and above the extension sections 312, extends through the aperture 234 in the upper cup 23 to connect co-movably with the sealing plate 26, and has two open-ended vertical slots 321 (see FIG. 3) formed in a lower end of the pushing post 32, and a shoulder 322 (see FIG. 3) disposed above the vertical slots 321. The holding sections 313 of the pushing member 31 are inserted respectively into the vertical slots 321 (see FIG. 3), such that the pushing post 32 is clamped between the holding sections 313. The pushing post 32 extends through the aperture 234 in the upper cup 23 and the inner ring portion 251 of the gasket 25, and has an upper end inserted fixedly into the sealing plate 26. The shoulder 322 of the pushing post 32 abuts against a bottom surface of the inner ring portion 251 of the gasket 25, such that the pushing post 32 is confined between the inner ring portion 251 and the pushing member 31. Alternatively, the pushing member 31 may be formed integrally with the pushing post 32.

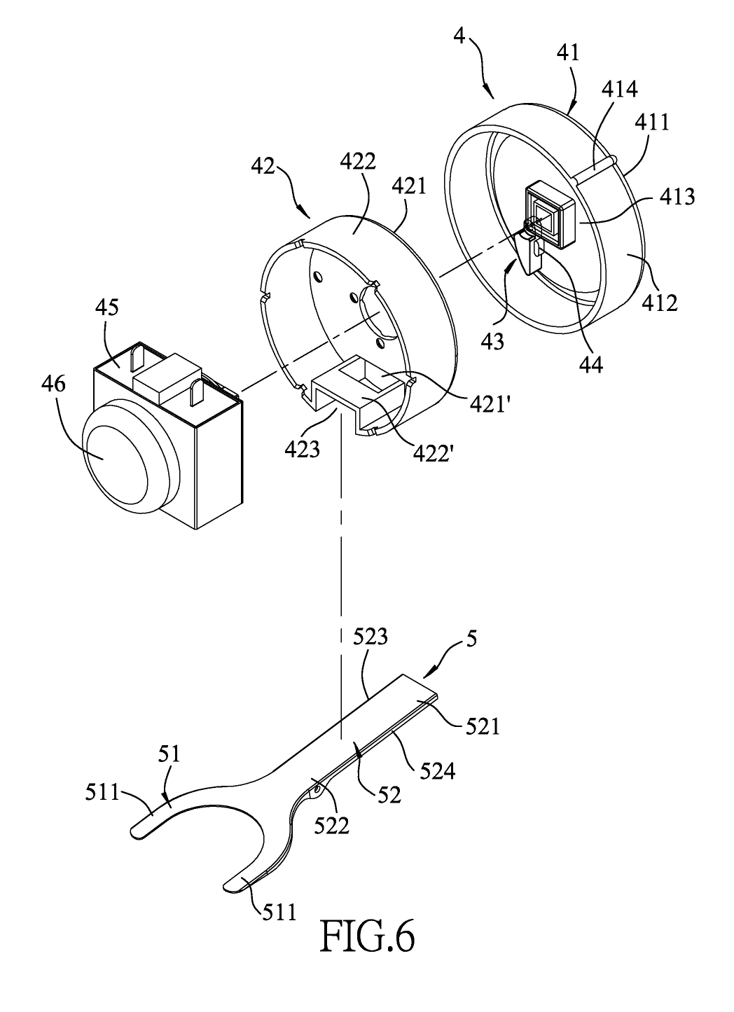

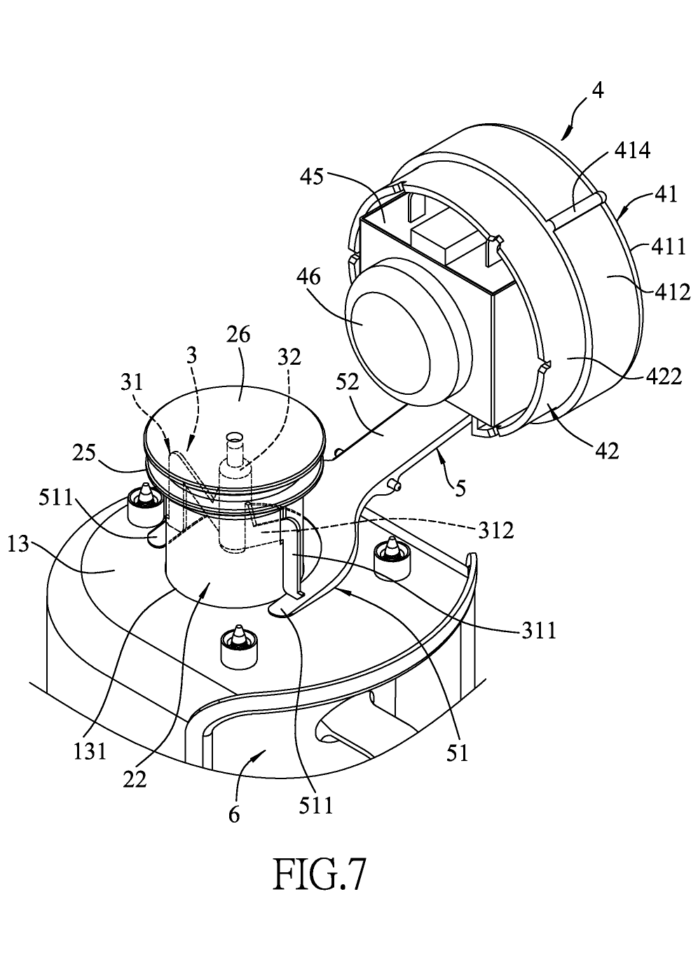

With further reference to FIGS. 6 and 7, the pivotable member 5 of the pushing unit 3 has a pushing section 51 disposed above the partition 13 of the base 1 and around the circular tube 22, and a pressed section 52 extending from the pushing section 51 toward the timer device 4. The pushing section 51 has two curved pushing portions 511 respectively disposed under and abutting against the pushed sections 311 of the pushing member 31. The pressed section 52 has a pressed portion 521 disposed at an end distal from the pushing section 51, and a pivot portion 522 connected between the pressed portion 521 and the pushing section 51 and connected pivotally to the pivot legs 213 of the cup mounting member 21. The pressed portion 521 has a first side 523 and a second side 524 that are opposite to each other. Alternatively, the pivotable member 5 may be formed integrally with the pushing member 31 and the pushing post 32.

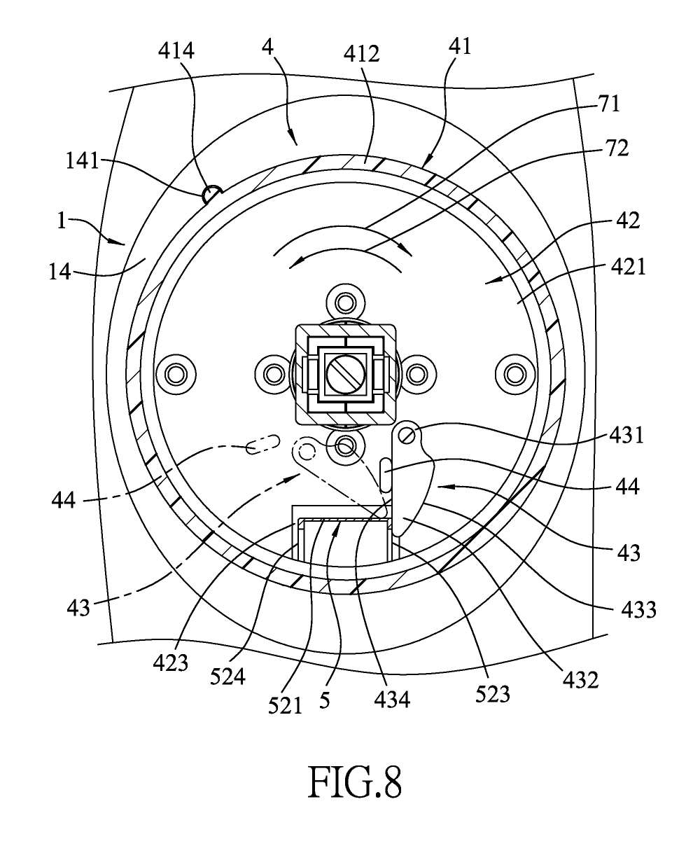

With further reference to FIG. 8, the timer device 4 includes a rotary knob 41 disposed rotatably on the mounting wall 14 of the base 1, a hollow fixed member 42 disposed fixedly on the mounting wall 14 of the base 1, a driving block 43 disposed pivotally on the rotary knob 41, a rotation limiting block 44, a timing unit 45, and a bell unit 46. As such, the timer device 4 is disposed on a lateral side of the base 1.

The rotary knob 41 is operable to rotate in a setting direction (i.e., clockwise direction) 71 or a timing direction (i.e., counterclockwise direction) 72 that is opposite to the setting direction 71. In this embodiment, the rotary knob 41 has a circular outer upright walls 411, and a rotatable surrounding wall 412 extending from a periphery of the outer upright wall 411 toward the upper cup unit 2. The outer upright wall 411 has a mounting side surface 413 facing the pushing unit 3. An outer surface of the rotatable surrounding wall 412 is provided with a timing graduation 414. The timing graduation 414 may be a mark or a projection.

The hollow fixed member 42 has an inner upright wall 421 disposed between the outer upright wall 411 and the upper cup unit 2 and having a through hole 421′ (see FIG. 6) formed therethrough, and a fixed surrounding wall 422 extending from a periphery of the inner upright wall 421 toward the upper cup unit 2 and having an inverted U-shaped wall portion 422′ (see FIG. 6). The inverted U-shaped wall portion 422′ defines a guide slot 423 in spatial communication with the through hole 421′. The guide slot 423 has a width slightly greater than that of the pressed section 52 of the pivotable member 5, so as to permit the pressed section 52 to extend through the guide slot 423 and the through hole 421′. The driving block 43 of the timer device 4 and the pressed portion 521 of the pivotable member 5 are disposed between the inner and outer upright walls 421, 411, and are adjacent to the inner upright wall 421.

The driving block 43 is disposed pivotally on the mounting side surface 413 of the rotary knob 41, and has a connecting portion 431 and a pushing portion 432 connected to the connecting portion 431. The driving block 43 has a curved pushing side surface 433 and a flat stop side surface 434 that are opposite to each other and that are positioned such that, when the rotary knob 41 is rotated in the setting direction, the stop side surface 434 comes into contact with the pressed section 52 of the pivotable member 5, and when the rotary knob 41 is rotated in the timing direction 72, the pushing side surface 433 comes into contact with the pressed section 52 of the pivotable member 5.

The rotation limiting block 44 is contactable with the stop side surface 434 of the driving block 43 for limiting the rotational angle of the driving block 43 when rotated in the setting direction 71. The timing unit 45 is disposed in the hollow fixed member 42, and activates the bell unit 46 to generate sound when a preset brewing time is reached. Since the timing unit 45 and the bell unit 46 are not pertinent to this invention, further description thereof will be omitted.

With particular reference to FIGS. 1 and 4, the lower cup 6 can be placed into or removed from the lower space portion 101 of the base 1 through the lower end notch 121 in the base 1. When disposed in the lower space portion 101, the lower cup 6 can be used for receiving brewed liquid flowing from the upper cup 23.

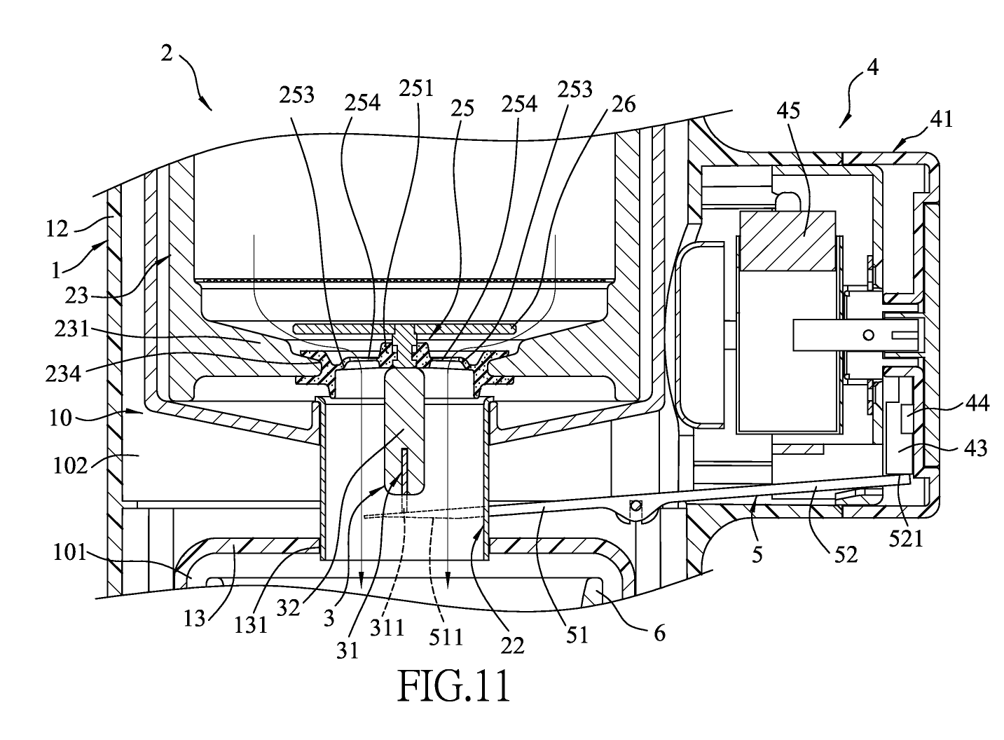

The pushing unit 3 is convertible between a non-pushing state shown in FIGS. 4 and 5 and a pushing state shown in FIG. 11. The sealing plate 26 is movable vertically in the upper cup 23 between a sealing position shown in FIGS. 4 and 5 whereat the aperture 234 is sealed by the sealing plate 26, and a non-sealing position shown in FIG. 11 whereat the aperture 234 is not sealed by the sealing plate 26 so as to allow the brewed liquid to flow downwardly from the upper cup 23 into the lower cup 6.

With particular reference to FIGS. 4, 5, and 8, when the pushing unit 3 is in the non-pushing state, the sealing plate 26 abuts against the bottom wall 231 of the upper cup 23 so as to seal the aperture 234, and thus is at the sealing position. In this state, the tea leaves can be placed into the upper cup 23, and subsequently water can be poured into the upper cup 23, so that a tea brewing operation is started. Also in this state, the timing graduation 414 of the rotary knob 41 is aligned with the indication member 141 of the base 1, and the stop side surface 434 of the driving block 43 of the timer device 4 abuts against the first side 523 of the pivotable member 5.

Subsequently, when the rotary knob 41 is rotated in the setting direction 71, the timing graduation 414 is rotated away from the indication member 141. The more the rotational angle of the timing graduation 414 is, the more the brewing time will be. The brewing time can be set according to the needs of the user. At an initial stage of rotation of the rotary knob 41 in the setting direction 71, the driving block 43 is rotated counterclockwise relative to the rotary knob 41, and is moved on the pressed portion 521 of the pivotable member 5, as shown by the phantom lines in FIG. 8. Thereafter, the driving block 43 moves past and separates from the pivotable member 5.

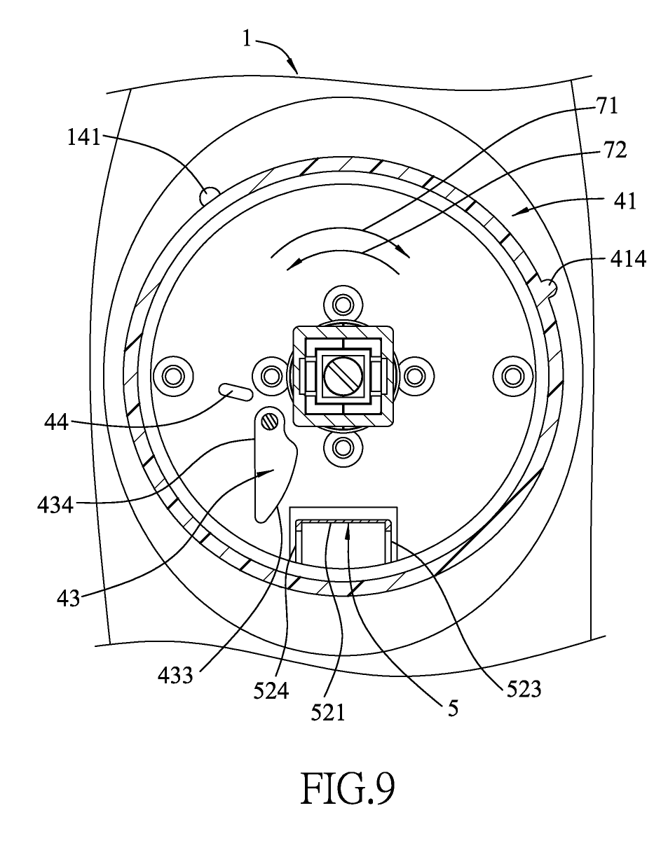

When the rotary knob 41 is rotated to a preset position shown in FIG. 9, corresponding to the desired brewing time and subsequently is released, it is automatically rotated in the timing direction 72 until the timing graduation 717 is aligned with the indication member 141 under control of the timing unit 45 of the timer device 4. As soon as rotation of the rotary knob 41 is stopped, the bell unit 46 is activated to generate sound, thereby completing the tea brewing operation.

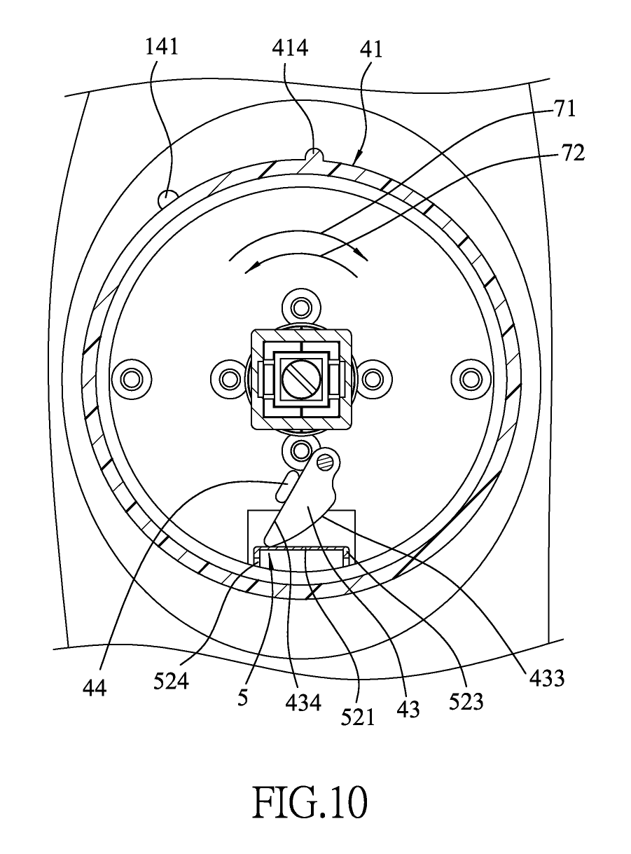

During automatic rotation of the rotary knob 41 in the timing direction 72, the curved pushing side surface 433 of the driving block 43 comes into contact with the second side 524 of the pressed portion 521 of the pivotable member 5 to rotate clockwise relative to the rotary knob 41, and subsequently, the flat stop side surface 434 of the driving block 43 comes into contact with the rotation limiting block 44, so that a further clockwise rotation of the driving block 43 relative to the rotary knob 41 is prevented. Hence, the curved pushing side surface 433 of the driving block 43 pushes downwardly the pressed portion 521 of the pivotable member 5 to thereby rotate the pivotable member 5 clockwise, as shown in FIG. 10. At the same time, the pushing section 51 of the pivotable member 5 pushes the pushing post 32 to move upwardly. As shown in FIG. 11, during upward movement of the pushing post 32, the connecting portions 253 of the gasket 25 is deformed to allow the sealing plate 26 to separate from the gasket 25 to thereby open the aperture 234. At this time, the sealing plate 26 is at the non-sealing position, and the brewed liquid can flow downwardly from the upper cup 23 into the lower cup 6 through a flowing path including the aperture 234, the passages 254 in the gasket 25, the circular tube 22, and the hole 131 in the partition 13. Subsequently, the lower cup 6 can be taken from the lower space portion 101 in the base 1 for tea drinking It should be noted that, due to the presence of the gasket 25, downward flow of the brewed liquid from the upper cup 23 can be retarded. This prevents the tea from splashing from the lower cup 6.

In this embodiment, during a tea brewing operation, the time required for moving the driving block 43 from the first side 523 to the second side 524 is several seconds. That is, the pushing unit 3 is maintained in the non-sealing state for several seconds. This time period is enough to allow the brewed liquid to flow completely from the upper cup 23 into the lower cup 6. Upon a lapse of the time period, the bell unit 46 is activated.

During rotation of the rotary knob 41 in the timing direction 72 from the position shown in FIG. 10 to the position shown in FIG. 8, since the pressed portion 521 of the pivotable member 5 is no longer pressed by the driving block 43, the pushing section 51 is pivoted downwardly, while the pressed portion 521 is pivoted upwardly, by virtue of the total gravity of the gasket 27, the sealing plate 26, and the pushing unit 3, until the sealing plate 26 comes into contact with the bottom wall 231 of the upper cup 23 (i.e., the sealing plate 26 returns to the sealing position), thereby allowing for a subsequent tea brewing operation.

It should be noted that, since the driving block 43 is disposed pivotally on the rotary knob 41, it can move from the position shown by the solid lines in FIG. 8 to that shown by the phantom lines in FIG. 8, so that the brewing time can be set before the tea leaves and water are moved into the upper cup 23 or after the tea leaves and water have been moved into the upper cup 23. Alternatively, to reduce the manufacturing costs of the tea brewing machine, the driving block 43 may be fixed on the rotary knob 41. If this occurs, the rotation limiting block 44 can be omitted from the timer device 4, and the brewing time must be set before the tea leaves and the water are moved into the upper cup 23 in order to avoid the tea leaves and water from dropping undesirably from the upper cup 23 into the lower cup 6.

In view of the above, through design of the timer device 4, the driving block 43, and the pushing unit 3, when the preset brewing time is reached, the sealing plate 26 can be automatically moved from the sealing position to the non-sealing position to thereby allow the brewed liquid to flow from the upper cup 23 into the lower cup 6, thereby resulting in convenience during use of the tea brewing machine.

With this invention thus explained, it is apparent that numerous modifications and variations can be made without departing from the scope and spirit of this invention. It is therefore intended that this invention be limited only as indicated by the appended claims.

What is claimed is:

1. A tea brewing machine comprising:
an upper cup unit including an upper cup, said upper cup including a bottom wall having an aperture, and a surrounding wall extending upwardly from a periphery of said bottom wall, said upper cup unit further including a sealing plate movable vertically in said upper cup between a sealing position whereat said aperture is sealed by said sealing plate, and a non-sealing position whereat said aperture is not sealed by said sealing plate so as to allow brewed liquid to flow downwardly from said upper cup through said aperture;
a pushing unit disposed under said upper cup unit and convertible between a non-pushing state and a pushing state such that, when said pushing unit is in said non-pushing state, said sealing plate is disposed at said sealing position, and when pushing unit is in said pushing state, said sealing plate is disposed at said non-sealing position, said pushing unit having a pressed section; and
a timer device including a rotary knob adjacent to and rotatable relative to said pressed section of said pushing unit, and a driving block disposed on said rotary knob, said rotary knob being operable to rotate in a selected one of a setting direction and a timing direction, which is opposite to said setting direction, such that, when said rotary knob is rotated in said timing direction, said driving block comes into contact and presses against said pressed section of said pushing unit to convert said pushing unit into said pushing state.

2. The tea brewing machine as claimed in claim 1, further comprising a base, said base including a lower surrounding wall defining an accommodating space, and a partition connected to and disposed in said lower surrounding wall and dividing said accommodating space into an upper space portion permitting said upper cup unit to be disposed therein, and a lower space portion disposed under said upper space portion, said partition having a hole disposed between and in fluid communication with said upper and lower space portions such that, when said sealing plate of said upper cup unit is disposed at said non-sealing position, said brewed liquid flows from said upper cup into said lower space portion through said aperture and said hole, said pushing unit being disposed above said partition, said timer device being disposed on a lateral side of said base.

3. The tea brewing machine as claimed in claim 2, wherein said pushing unit includes a pushing member, a pushing post disposed on and above said pushing member, and a pivotable member disposed under said pushing member and having said pressed section, said pushing member having two upright pushed sections, and two inclined extension sections extending respectively from upper ends of said upright pushed sections toward each other and connected to each other at lower ends of said extension sections, said pushing post being disposed on said extension sections and extending through said aperture in said upper cup and to connect co-movably with said sealing plate, said pivotable member having a pushing section connected to said pressed section and disposed under and abutting against said pushed sections of said pushing member, said pressed section having a pressed portion contactable with said driving block of said timer device, and a pivot portion connected between said pressed portion and said pushing section and rotatable relative to said base.

4. The tea brewing machine as claimed in claim 3, wherein said upper cup unit further includes a hollow cup mounting member disposed on said partition and permitting said upper cup to be disposed removably therein, said cup mounting member including a hollow receiving body and at least one pivot leg extending downwardly from said hollow receiving body and connected pivotally to said pivot portion of said pivotable member, said hollow receiving body having an opening that is formed in a bottom end thereof and that is disposed under said aperture in said upper cup.

5. The tea brewing machine as claimed in claim 4, wherein said upper cup unit further includes a circular tube having a bottom end fixed on said partition and extending into said cup mounting member through said opening, said circular tube having an open upper end and two diametrically opposed slide slots that are formed in said open upper end of said circular tube and that have open upper ends, said pushed sections of said pushing member being disposed outwardly of said circular tube, said extension sections of said pushing members extending into said circular tube through said slide slots and being movable vertically relative to said circular tube along said slide slots, said pushing section of said pivotable member being disposed around said circular tube.

6. The tea brewing machine as claimed in claim 2, wherein said base further includes an annular mounting wall extending laterally from an outer surface of said lower surrounding wall, said rotary knob of said timer device being mounted to said mounting wall and having an outer upright wall and a rotatable surrounding wall extending from a periphery of said outer upright wall toward said upper cup unit, said outer upright wall having a mounting side surface facing said pushing unit, said driving block being disposed pivotally on said mounting side surface.

7. The tea brewing machine as claimed in claim 6, wherein said timer device further includes a hollow fixed member disposed fixedly on said mounting wall of said base, a timing unit disposed within said hollow fixed member, and a bell unit controlled by said timing unit to generate sound, said hollow fixed member having an inner upright wall disposed between said outer upright wall and said upper cup unit and having a through hole formed therethrough, a fixed surrounding wall extending from a periphery of said inner upright wall toward said upper cup unit and having an inverted U-shaped wall portion, said inverted U-shaped wall portion defining a guide slot in spatial communication with said through hole, said guide slot having a width slightly greater than that of said pressed section of said pivotable member, so as to permit said pressed section to extend through said guide slot and said through hole, said driving block of said timer device being disposed between said inner and outer upright walls and being adjacent to said inner upright wall.

8. The tea brewing machine as claimed in claim 7, wherein said driving block has a stop side surface and a pushing side surface that are opposite to each other, said stop side surface coming into contact with said pressed section of said pivotable member when said rotary knob is rotated in said setting direction, said pushing side surface coming into contact with said pressed section of said pivot member when said rotary knob is rotated in said timing direction, said timer device further including a rotation limiting block contactable with said stop side surface of said driving block for limiting a rotational angle of said driving block when rotated in said setting direction.

9. The tea brewing machine as claimed in claim 1, wherein said upper cup unit further includes a gasket disposed under said sealing plate and within said aperture in said upper cup, said gasket having an inner ring portion, an outer ring portion disposed around and spaced apart from said inner ring portion, and a plurality of connecting portions connected between said inner and outer ring portions and spaced apart from each other, so as to define a plurality of passages each disposed among said inner and outer ring portions and two adjacent ones of said connecting portions.

10. The tea brewing machine as claimed in claim 1, further comprising a lower cup disposed under said upper cup so as to receive said brewed liquid flowing from said upper cup.

11. The tea brewing machine as claimed in claim 10, further comprising a base, said base including a lower surrounding wall defining an accommodating space, and a partition connected to and disposed in said lower surrounding wall and dividing said accommodating space into an upper space portion permitting said upper cup unit to be disposed therein, and a lower space portion disposed under said upper space portion, said partition having a hole disposed between and in fluid communication with said upper and lower space portions, said lower cup being disposed removably within said lower space portion such that, when said sealing plate is disposed at said non-sealing position, said brewed liquid can flow from said upper cup into said lower cup through said aperture and said hole.
